(19) United States
(12) Patent Application Publication
(10) Pub. No.: US 2017/0026691 A1
(43) Pub. Date: Jan. 26, 2017

(54) SATELLITE RECEIVER AND COMMUNICATION METHOD FOR SATELLITE RECEIVERS

(71) Applicant: THOMSON LICENSING, Issy-les-Moulineaux (FR)

(72) Inventors: Zhiyi LI, Beijing (CN); Bingdan SHI, Beijing (CN)

(21) Appl. No.: 15/107,254

(22) PCT Filed: Dec. 25, 2013
(86) PCT No.: PCT/CN2013/090411

§ 371 Date: Jun. 22, 2016

(51) Int. Cl. H04N 21/436; H04N 21/61; H04N 21/438; H04N 21/6371; H04N 7/20; H04N 7/10

(52) U.S. Cl. CPC H04N 21/43615; H04N 7/20; H04N 7/10; H04N 21/4383; H04N 21/6371; H04N 21/6143

(57) ABSTRACT

A satellite receiver and a communication method for satellite receivers are described. The satellite receiver is in a network having a plurality of satellite receivers. Each of the plurality of satellite receivers is allocated with a unique address. The satellite receiver comprises: a first module for transmitting a message according to DiSEqC protocol over a co-axial cable to one or more of other satellite receivers in the network, the message indicating the address of the one or more of other satellite receivers; and a second module for receiving a message over the co-axial cable from one or more of other satellite receivers in the network.

### TECHNICAL FIELD

The present invention generally relates to network technology. In particular, the present invention relates to a satellite receiver and a communication method for satellite receivers.

### BACKGROUND

DiSEqC (Digital Satellite Equipment Control) is a special communication protocol between a satellite receiver and a satellite peripheral apparatus, such as a signal switch, a low noise block (LNB) or a small dish antenna, using only the existing co-axial cable. A satellite STB (Set-Top-Box), which embodies a satellite receiver, can use the DiSEqC protocol to control one or more peripheral apparatus to get correct signals from a satellite. In such a case, normally the STB acts as the master and the one or more peripheral apparatus act as slaves. With the commands defined in the DiSEqC protocol, a STB can for example control a signal switch to carry out a switching operation, a LNB to switch the frequency, and an antenna to rotate. Current DiSEqC protocol can only support a communication between a satellite receiver and one or more satellite peripheral apparatus. It does not support a communication between satellite receivers.

However, in some cases in practice, there is a need for a communication between satellite receivers. For example, a commercially available STB product normally is not provided with a serial port, without which the STB cannot catch a log. In such a case, if a STB fails to work properly due to technical malfunction, it is almost impossible for the STB to inform the corresponding party for analyzing the issue and troubleshooting.

### SUMMARY

In view of the above problem in the known technologies, the invention provides a satellite receiver and a communication method for satellite receivers which can realize a bidirectional communication between satellite receivers with an adapted DiSEqC protocol.

According to one aspect of the invention, a satellite receiver in a network having a plurality of satellite receivers is provided. Each of the plurality of satellite receivers is allocated with a unique address. The satellite receiver comprises: a first module for transmitting a message according to DiSEqC protocol over a co-axial cable to one or more of other satellite receivers in the network, the message indicating the address of the one or more of other satellite receivers; and a second module for receiving a message over the co-axial cable from one or more of other satellite receivers in the network.

According to one aspect of the invention, a communication method between a first satellite receiver and a second satellite receiver in a network is provided. Each of the first satellite receiver and the second satellite receiver being allocated with a unique address. The method comprises the steps of: transmitting a message by the first satellite receiver according to DiSEqC protocol over a co-axial cable to the second satellite receiver, the message indicating the address of the second satellite receiver; and receiving the message by the second satellite receiver over the co-axial cable from the first satellite receiver.

It is to be understood that more aspects and advantages of the invention will be found in the following detailed description of the present invention.

### BRIEF DESCRIPTION OF THE DRAWINGS

The accompanying drawings are included to provide further understanding of the embodiments of the invention together with the description which serves to explain the principle of the embodiments. The invention is not limited to the embodiments.

In the drawings:

FIG. 1 is an exemplary diagram showing the network structure for implementing a bidirectional communication between satellite STBs according to an embodiment of the invention;

FIG. 2 is an exemplary diagram showing the high level structure of a message used in the bidirectional communication between satellite STBs according to an embodiment of the invention;

FIG. 3 is an exemplary diagram showing the detailed definitions of the message used in the bidirectional communication between satellite STBs according to an embodiment of the invention;

FIG. 4 is an exemplary diagram showing the process of a failed STB reporting its failure status according to an embodiment of the invention;

FIG. 5 is an exemplary diagram showing the process of a master STB controlling slave STBs according to an embodiment of the invention; and

FIG. 6 is an exemplary diagram showing the process of data transmission of a STB without serial port according to an embodiment of the invention.

### DETAILED DESCRIPTION

An embodiment of the present invention will now be described in detail in conjunction with the drawings. In the following description, some detailed descriptions of known functions and configurations may be omitted for conciseness.

An embodiment of the invention provides a satellite receiver and a communication method for satellite receivers which can implement a bidirectional communication between satellite receivers.

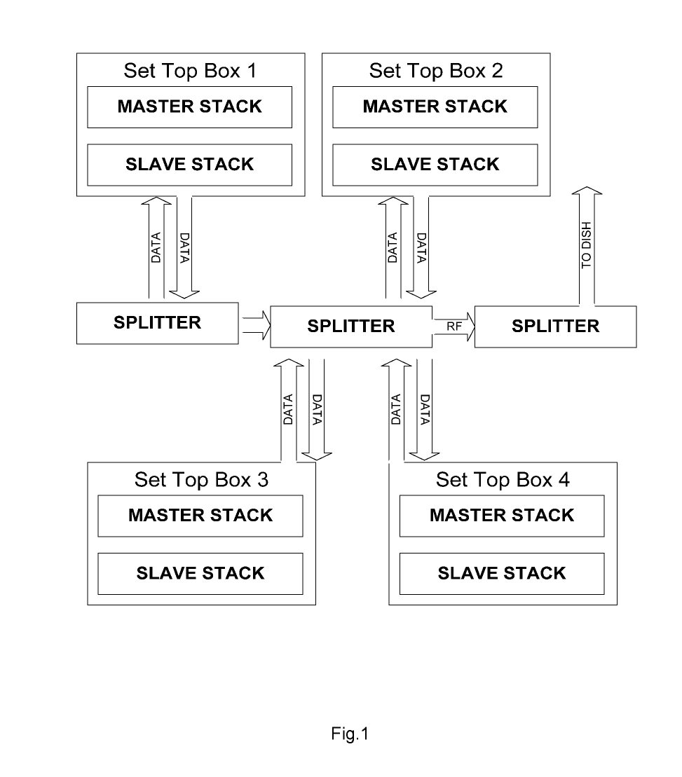

FIG. 1 is an exemplary diagram showing the network structure for implementing a bidirectional communication between satellite STBs according to an embodiment of the invention.

As shown in FIG. 1, for illustrative purpose only, four satellite STBs are shown in the network, which are indicated as STB1, STB2, STB3 and STB4. It can be appreciated that a network can comprise more or less number of satellite receivers. The communication among STB1-STB4 runs on a co-axial cable, which is the medium defined by the DiSEqC protocol for the message exchange. One or more splitters are added into the network for splitting signals from multiple STBs into multipath, i.e., dividing RF power from an input into multiple outputs. Since co-axial cable is used for the network, DC-pass splitters should be used, which “passes” DC voltages/currents from its input to its output.

Each STB participating in the network will be allocated with a unique address for implementing a bidirectional communication therebetween according to the embodiment of the invention. It can be appreciated that any appropriate form of numerical label can be used for addressing the STB. For example, if the number of STBs in the network is limited, a number in the hexadecimal format is sufficient for this purpose. For a more complicated network topology, an IP (Internet Protocol) address like addressing system can be designed.

As shown in FIG. 1, each STB comprises a first module for transmitting a message over the co-axial cable to the other STBs in the network. The message indicating the address of the one or more of other satellite STBs. The STB further comprises a second module for receiving a message over the co-axial cable from the other STBs.

As to be described below, the transmitted message can comprises a command. A STB which receives the message can execute the command in the message. The transmitted message can also comprise data. A STB which receives the message can read, parse and process the data in the message.

The first and second modules can be implemented by stacks. In computer science, a stack is a particular kind of abstract data type or collection in which the principal operations on the collection are push (the addition of an entity to the collection) and pop (removal of an entity from the collection). The push and pop operations has a Last-In-First-Out (LIFO) data structure, which means that the last element added to the structure must be the first one to be removed. Although a stack may have more operations than “push” and “pop” in many implementations, basically it is a restricted data structure because of the small number of operations performed thereon.

In the sense that the first module will initiate a communication and the second module receives a message and executes any request or command in the received message from other STBs, the first stack is a master and the second stack is a slave. Therefore, in FIG. 1, the first module of each STB is shown as a master stack and the second module is shown as a slave stack.

In this embodiment, the operations carried out by a master stack may comprise:

1. broadcasting commands (zapping, channel lock etc) to all other STBs in the network;

2. transmitting a command to a specific STB by assigning the command to a specific address;

3. broadcasting self-status to the network;

4. transmitting self-status to a specific address; and

5. transmitting information by request (usually from another master stack).

The operations carried out by a master stack may comprise:

1. receiving a command and executing the command (for example, switch to another channel, power off, lock specific channel);

2. receiving information requested by a master stack; and

3. monitoring the network status.

With the master and slave stacks provided in each STB in the network, the STBs in the network can operate in a master-slave mechanism. Specifically, a master STB in the network can initiate a communication, for example, by transmitting a DiSEqC like message to other STBs as a control command. A slave STB can receive and parse the DiSEqC message and then, for example, execute a command in the message, such as zapping, stand-by. In this way, the master STB can somehow control the slave STBs. In view of the fact that each STB is provided with both a master stack and a slave stack, the master-slave mechanism according to the embodiment of the invention is a dynamic one. That is, each STB can be a master in some cases while becomes a slave in other cases.

A network monitoring mechanism can be introduced so that all the master STB and slave STBs can transfer data at the same time. To avoid a collision of transmitted messages in this case, a media access control mechanism similar to Carrier Sense Multiple Access with Collision Detection (CSMA/CD) in Ethernet can be applied in this network. Generally a CSMA/CD mechanism uses a carrier sensing scheme in which a transmitting data station detects other signals while transmitting a frame, and stops transmitting that frame, transmits a jam signal, and then waits for a random time interval before trying to resend the frame. No further details will be given in this respect.

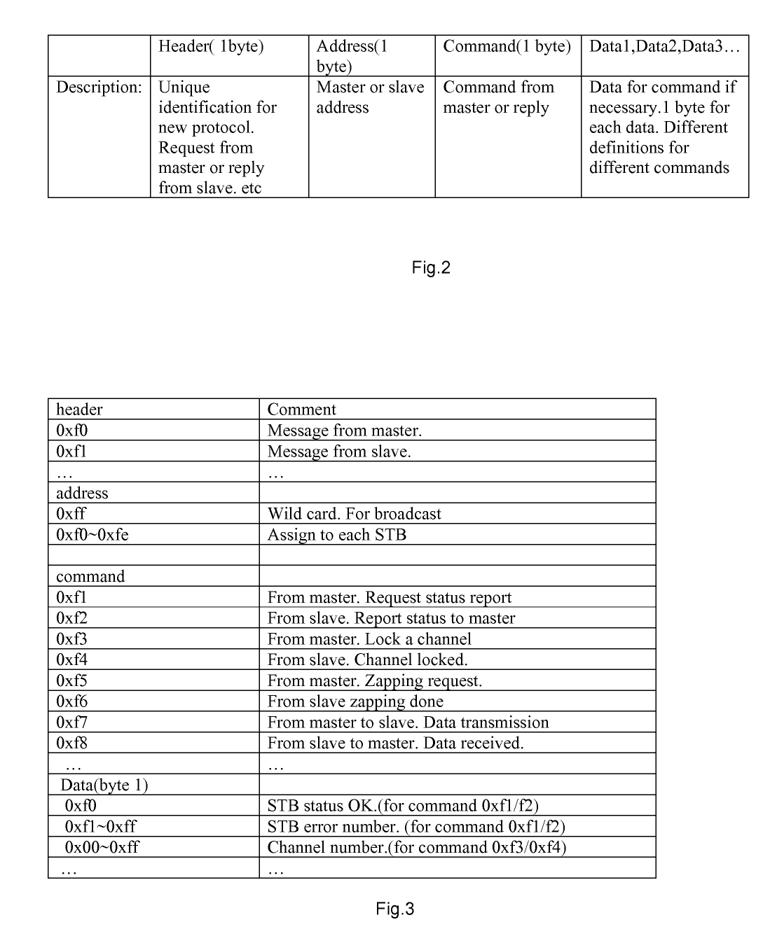

FIG. 2 is an exemplary diagram showing the high level structure of a message used in the bidirectional communication between satellite STBs according to an embodiment of the invention.

As shown in FIG. 2, a message used in the bidirectional communication between satellite STBs can comprise the following fields:

Header (1 byte): a unique identification for identifying whether the command is a request from a master or a reply from a slave;

Address (1 byte): an address of a device;

Command (1 byte): a request from a master or a reply from a slave; and

Data: a field for data of command if any, multiple data field is possible, 1 byte for each data, which can have different definitions for different command.

FIG. 3 is an exemplary diagram showing the detailed definitions of the message used in the bidirectional communication between satellite STBs according to an embodiment of the invention.

As shown in FIG. 3, some examples of the command structure are defined. For example, for the header, a numerical label “0xf0” is defined for a message from a master and “0xf1” for a message from a slave. For the address field, “0xff” is for a wild card for broadcasting and the numerical labels “0xf0˜0xfe” are allocated respectively to each STB in the network.

In the message structure shown in FIG. 3, several specific commands which can be carried by the message are defined, as below:

0xf1: a command from a master to request status report;

0xf2: a command from a slave to report status to a master;

0xf3: a command from a master to lock a channel;

0xf4: a command from a slave to report channel locked;

0xf5: a command from a master for zapping request;

0xf6: a command from a slave to report zapping done;

0xf7: a command from a master to a slave for data transmission; and

0xf8: a command from a slave to a master report data received.

Several examples for the data field are also given in FIG. 3. For example, in a data1 field, “0xf0” indicates STB status OK in response to command 0xf1/0xf2; “0xf1˜0xff” are error numbers each of which respectively indicates a type of error in response to command 0xf1/0xf2; and “0x00˜0xff” are channel numbers in response to command 0xf3/0xf4.

Next, a communication method for satellite receivers according to an embodiment of the invention will be described in details with reference to several context of application.

### Example 1

### STBs Reporting Self-Test Status

Currently a mass produced satellite STB is normally not provided with a RS-232 port which is a serial port commonly used in data terminal equipments (such as personal computers and printers) for the communication of serial binary single-ended data and control signals. If such a STB fails on field, it is difficult to tell what happens to the STB. With the satellite STB and message structure described above, a failed STB can inform other STBs the reason of its failure over the co-axial cable network, for example, by broadcasting an error code to other STBs in the network as long as its master stack works properly.

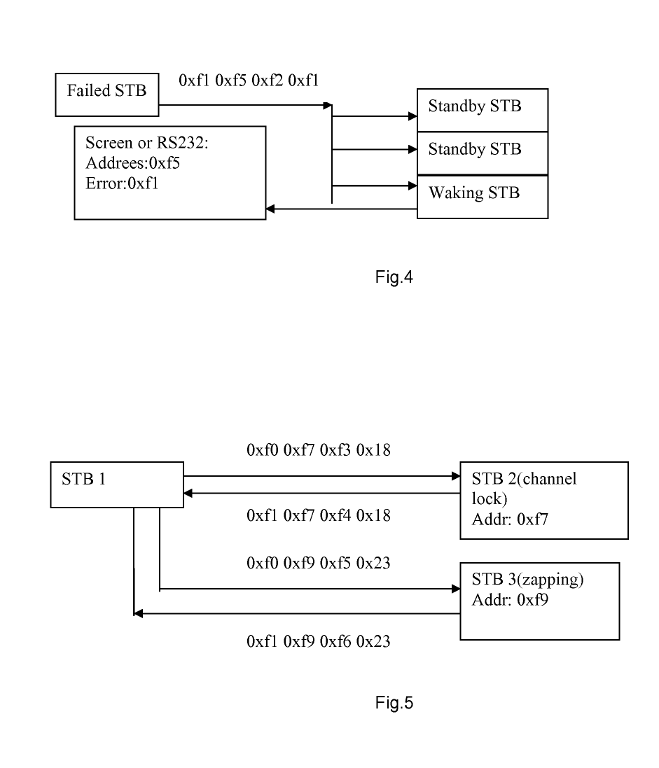

FIG. 4 is an exemplary diagram showing the process of a failed STB reporting its failure status according to an embodiment of the invention.

In the situation above, a failed STB sends a broadcasting message by its master stack to all the STBs in the network. The message contains the address of the failed STB and the reason of failure. The reason of the failure can be obtained by analyzing the log of the failed STB internally. In this example, the message is in the form of “0xf1; 0xf5; 0xf2; 0xf1”. The header “0xf1” indicates that the message is from a slave STB and the address “0xf5” is the address in the network which is allocated to the STB. The command “0xf2” shows that the message is a command from a slave to report its status to a master. The data field “0xf1” is an error number indicating the error of the STB.

Any other STBs in the network, including the one in standby mode, can receive the message with their respective slave stack. The STB which receives the message can parse the message and display corresponding information on its screen or at RS-232 (if it has). The information can comprise the identification number of the failed STB and the received error code. For example, as shown in FIG. 4, the address of the failed STB “0xf5” and the error code “0xf5” are displayed on the screen of a normal STB which receives the message and awake at that moment.

### Example 2

### Dynamic Control

With the communication method of the embodiment of the invention, a master STB can control one or more slave STBs. This is meaningful in a case that, in a home network having more than one STB, the parent may want to control other STBs (used by kids) by their own STB without making kids feel uncomfortable.

FIG. 5 is an exemplary diagram showing the process of a master STB controlling slave STBs according to an embodiment of the invention.

As shown in FIG. 5, the STB1 in the network of FIG. 1 is shown to be the STB of the parent, as the master. The STB1 can control two STBs, STB2 and STB3 in the network of FIG. 1, which are the slaves in this case. The STB2 and STB3 are respectively allocated with an address of 0xf7 and 0xf9 in the network.

In this example, the STB1 transmits a message to STB2 for a channel lock. The message is in the form of “0xf0 0xf7 0xf3 0x18”, which means:

1. the message is transmitted from a master;

2. the destination of the message is address 0xf7;

3. the message contains a command for lock channel; and

4. the channel to be locked is coded 0x18 which is channel 24.

When the STB2 with address 0xf7 receives the message, it will parse the message and execute the command. Then STB2 transmits a message to STB1 in the form of “0xf1 0xf6 0xf4 0x18”, which means:

1. the message is transmitted from a slave;

2. the destination of the message is address 0xf6;

3. the message contains a command to report channel locked; and

4. the locked channel is coded 0x18 which is channel 24.

As shown in FIG. 5, the STB1 transmits a message to STB3 for a zapping request. The message is in the form of “0xf0 0xf9 0xf5 0x23”, which means:

1. the message is transmitted from a master;

2. the destination of the message is address 0xf9;

3. the message contains a command for zapping request; and

4. data field for zapping.

When the STB3 with address 0xf9 receives the message, it will parse the message and execute the command. Then STB3 transmits a message to the STB1 in the form of “0xf1 0xf6 0xf6 0x23”, which means:

1. the message is transmitted from a slave;

2. the destination of the message is address 0xf6;

3. the message contains a command to report zapping done; and

4. data field for zapping.

### Example 3

### Data Transmission

The current DiSEqC protocol can only support the transmission of command, instead of data. With the method and message structure of the embodiment of the invention, a mass data transmission can be implemented even though the band width of the DiSEqC protocol is limited. The data transmission of a satellite STB over co-axial cable is interesting for industrial purpose, such as monitoring and debugging.

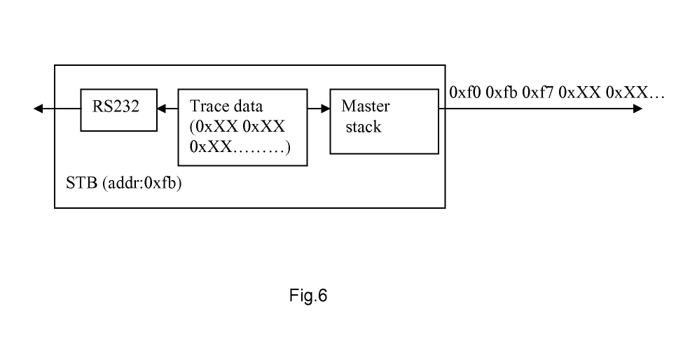

FIG. 6 is an exemplary diagram showing the process of data transmission of a STB without serial port according to an embodiment of the invention.

In FIG. 6, RS-232 (serial port) trace data is shown to be transmitted with the communication method according to the embodiment of the invention. As described above, the RS-232 is commonly used in computer serial ports; and almost all debugging information of a STB is obtained from a RS-232 port. Therefore, it is meaningful for a STB without a RS-232 port to transmit RS-232 trace data over the co-axial cable with the method of the invention.

As shown in FIG. 6, a STB in the network has RS-232 trace data in the form of “0xXX, 0xXX, 0xXX . . . ”. The master stack of the STB transmits a massage including the trace data to another STB in the network. As described above, the message structure defined in the embodiment of the invention can carry a plurality of data parts in the data field. In FIG. 6, the transmitted message is in the form of “0xf0 0xfb 0xf7 0xXX 0xXX . . . ”, wherein the trace data is in the data field.

A STB in the network which receives the message can read out the data and translate it into a RS-232 trace. If the STB which receives the message is provided with a serial port, it can transmit the information of the RS-232 trace through the RS-232 serial port to the STB manufacture or post sale center, where analysis and troubleshooting can be made.

With this example, a STB without a serial port can output a log as a DiSEqC message; and a STB with a serial port can transmit the DiSEqC message to a corresponding party. Therefore, information of RS-232 trace data can be collected for mass produced STBs which are not provided with RS-232 port.

Since the RS-232 trace data is commonly used in the field of satellite receiver, the embodiment of the invention is described with reference to an example for communicating RS-232 trace data between satellite STBs. However, it can be appreciated that other types of data can also be transmitted with the communication method according to the embodiment of the invention.

It is to be further understood that, because some of the constituent system components and method steps depicted in the accompanying figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

1. A satellite receiver in a network having a plurality of satellite receivers, each of which is allocated with a unique address, comprising:
a first module for transmitting a message according to DiSEqC protocol over a co-axial cable to one or more of other satellite receivers in the network, the message indicating the address of the one or more of other satellite receivers; and
a second module for receiving a message over the co-axial cable from one or more of other satellite receivers in the network.

2. The satellite receiver according to claim 1, wherein the transmitted message comprises a command for executing by the one or more of other satellite receivers with the indicated address.

3. The satellite receiver according to claim 1, wherein the transmitted message comprises data for reading by the one or more of other satellite receivers with the indicated address.

4. The satellite receiver according to claim 1, wherein
the second module executes a command in the transmitted message.

5. The satellite receiver according to claim 1, wherein
the second module reads and parses data in the transmitted message.

6. The satellite receiver according to claim 1, wherein the satellite receiver operates as a master when the first module transmits a message over a co-axial cable to one or more of other satellite receivers in the network.

7. The satellite receiver according to claim 1, wherein the satellite receiver operates as a slave when the second module receives a message over a co-axial cable from one or more of other satellite receivers in the network.

8. A communication method between a first satellite receiver and a second satellite receiver in a network, each of the first satellite receiver and the second satellite receiver being allocated with a unique address, comprising the steps of:
transmitting a message by the first satellite receiver according to DiSEqC protocol over a co-axial cable to the second satellite receiver, the message indicating the address of the second satellite receiver; and
receiving the message by the second satellite receiver over the co-axial cable from the first satellite receiver.

9. The communication method according to claim 8, wherein the transmitted message comprises a command for executing by the second receiver and data for reading by the second satellite receiver.

10. The communication method according to claim 9, wherein the transmitted message comprises a command and data for reporting a self-test status of the first satellite receiver to the second satellite receiver.

11. The communication method according to claim 10, wherein the second satellite receiver displays information of the self-test status of the first satellite receiver.

12. The communication method according to claim 9, wherein the transmitted message comprises a command and data for reporting a RS-232 trace data of the first satellite receiver to the second satellite receiver.

13. The communication method according to claim 12, wherein the second satellite receiver transmits the RS-232 trace data of the first satellite receiver to a device.

14. The communication method according to claim 9, wherein the transmitted message comprises a command and data for carrying out a control of the second satellite receiver.

15. The communication method according to claim 9, wherein the control of the second satellite receiver comprises a channel lock and a zapping of the second satellite receiver.
